(19) United States
(12) Patent Application Publication
(10) Pub. No.: US 2020/0317443 A1
(43) Pub. Date: Oct. 8, 2020

(54) BAG-CLOSING DEVICE AND SHREDDER EQUIPPED WITH DEVICE

(71) Applicant: NAKABAYASHI CO., LTD., Osaka-shi, Osaka (JP)

(72) Inventors: Yoji MAEDA, Shimane (JP); Shigeru FUJIMORI, Shimane (JP); Wataru NAGAO, Shimane (JP)

(21) Appl. No.: 16/305,177

(22) PCT Filed: Jun. 2, 2017
(86) PCT No.: PCT/JP2017/020633

§ 371 Date: Nov. 28, 2018

(30) Foreign Application Priority Data
Jun. 2, 2016 (JP) 2016-110627
Oct. 4, 2016 (JP) 2016-196664

(51) Int. Cl. B65F 1/00; B65F 1/14; B65D 33/16; B02C 18/00; B02C 18/22

(52) U.S. Cl. CPC B65F 1/002; B65F 1/1415; B65F 2250/114; B02C 18/0007; B02C 18/2216; B65D 33/16

(57) ABSTRACT

A bag-closing device is disclosed which is capable of using general-purpose bags and which keeps the loss of capacity to the necessary minimum, and a shredder is provided which, even when shredded pieces of trash are stored in a bag, does not cause scattering of the shredded pieces of trash when closing the bag. The bag-closing device comprises one pair of horizontally facing winding shafts having tip parts for detachably holding a bag, which is open so as to allow objects to be put inside, at two facing opening edge parts from the outside of the bag, whereby the entire opening edge of the bag containing objects put therein is formed into a single horizontal roll-like shape by driving the one pair of winding shafts to rotate. In addition, the device may be provided with a cabinet, which allows a frame having one pair of winding shafts to be stored therein and to be pulled out therefrom together with a bag in an open state, and configured such that the one pair of winding shafts are restricted from rotating when the frame is pulled out from the cabinet whereas the one pair of winding shafts are allowed to rotate when the frame is placed in the cabinet. It is also feasible to construct a shredder having this bag-closing device installed below a shredding unit. In this case, preferably outer peripheral surfaces at the tips of the winding shafts are formed into a tapered shape.

### TECHNICAL FIELD

The present invention relates to a technique of packaging a waste bag containing shreds shredded by a shredder, and more specifically to a bag-closing device for winding a bag mouth in a roll state to finally tie down a mouth of a waste bag by hand, and a shredder provided with the device.

### BACKGROUND

When shreds put through a shredder are packed into a bag to be discarded, the bag with an appropriate size is set under a shredding unit while being opened, and when the shreds reach a predetermined volume, the bag is taken out while a bag mouth is closed by tying two places in the opening at its center, in general. However, this method may cause the shreds in the bag to be scattered from the bag mouth due to wind pressure caused when the opening is tied down to compress the bag. Particularly, a cross-cut type shredder cuts shreds into tiny pieces, so that the shreds are likely to fly up even with a slight wind pressure.

Meanwhile, a shredder that automatically packs a waste bag containing shreds has also been proposed. Japanese Open Gazette No. H6-15192 discloses a shredder that has a mechanism for compressing and packing a large volume of shreds, and this compression mechanism causes a structure to be large. In light of this problem, Japanese Open Gazette No. 2014-161753 discloses a shredder that includes a rotating mechanism that horizontally rotates a waste bag to form a twisted portion (portion to be tied) and a tying device that ties up the twisted portion, so that reduction in overall size and a low cost are to be achieved.

The shredder disclosed in Japanese Open Gazette No. H6-15192 is so extremely large in size that it cannot be installed in a normal office, and is also expensive.

Meanwhile, the shredder disclosed in Japanese Open Gazette No. 2014-161753 is dedicated to using a bag in an elongated tubular shape with open top and bottom, and thus it is impossible to use a general-purpose garbage bag whose bottom is closed from the beginning.

That shredder also takes time to fix upper and lower sides of a bag when a twisted portion is formed in the bag containing shreds.

In addition, that shredder causes a bottom portion of a bag containing shreds to horizontally rotate with a rotary table while an opening of the bag is fixed to form a twisted portion. In this case, the twist portion is formed below the opening, so that the volume of accommodated shreds is sacrificed. On this point, while a bag with a large bag mouth allows waste to be easily thrown therein and is suitable for throwing a large volume of waste at a time, a larger bag mouth lowers a position of a twisted portion. As a result, an expected volume of accommodation of waste cannot be achieved.

The present device is made to solve the problem described above, and an object thereof is not only to disclose a bag-closing device capable of using a general-purpose bag and reducing loss of the volume of accommodation of the bag to the minimum, but also to provide a shredder that does not scatter shreds even when the bag accommodating the shreds as accommodating objects is closed.

### SUMMARY

To achieve the above object, the present device uses means including a pair of winding shafts having leading end portions for detachably holding, from outside of a bag, two respective opposing places in a mouth edge of the bag that is opened to allow accommodating objects to be thrown in the bag, the shafts facing each other horizontally, wherein the pair of winding shafts is rotationally driven so that the whole of the mouth edge of the bag into which the accommodating objects are thrown is formed in a horizontal single roll shape with the two places in the mouth edge held by the respective leading end portions, serving as opposite ends.

According to the above means, when the pair of winding shafts is rotationally driven at the same time, the mouth edge of the bag is started to be wound almost simultaneously in a horizontal line. As a result, even when accommodating objects are extremely lightweight materials such as shreds, the accommodating objects are not scattered from the bag mouth while the bag mouth is formed in a single roll shape. While a rotation direction of the winding shaft, a rotational driving source, and rotation speed are not limited, the rotational direction is preferably set such that the pair of winding shafts is rotated in directions opposite to each other so as to twist the entire mouth edge not only to be more tightly sealed than rotating in the same direction but also to cause the twist of the bag mouth to be less likely to unwind. As for the driving source, an electric motor enables this apparatus to be used as an automatic packing apparatus. As for the rotation speed, when the mouth edge is slowly wound up, no wind pressure for blowing up the shreds is generated even when air in the bag is evacuated from the bag mouth. This enables scattering of the shreds to be more reliably avoided.

The above means can close a bag mouth with a slight winding by forming the entire mouth edge of a bag in a horizontal single roll shape, so that accommodating objects can be accommodated while loss of the volume of accommodation is minimized. The number of turns of the winding shaft also may be appropriately determined to close a bag mouth. While a higher number of winding turns enhances sealing performance of a bag, the winding shaft is not necessarily rotated more than one turn as long as opposite ends of a bag mouth are tied down in a roll shape finally, as described below.

After the entire mouth edge is formed in a roll shape as described above, opposite ends thereof are removed from the pair of winding shafts by axially pulling them, for example. In addition, after the entire mouth edge is removed from the winding shafts, it is easy not only to fasten the mouth edge with a tape to prevent it from opening, but also to tie down opposite ends thereof at its center by hand.

As a specific structure, there can be further provided a casing having an upper surface serving as an input port of accommodating objects, the casing being capable of placing a bag in an open state, and a pair of winding shafts can be provided inside the casing while facing each other. It is a matter of course that the bag accommodated in the casing is closed with a bag mouth in a roll shape from the open state by rotationally driving the pair of winding shafts after accommodating objects are thrown.

Besides this, there can be further provided with a frame in which a bag is attachable in an open state, and a pair of winding shafts can be provided at two respective places in a mouth edge of the bag attached to the frame, the two places facing each other. This case also causes the bag to be closed with a bag mouth in a roll shape from the open state by rotationally driving the pair of winding shafts after accommodating objects are thrown to gradually wind the bag mouth.

In addition, a device may be configured by combining the casing and the frame. That is, the device can have a structure further including a frame provided with a pair of winding shafts and being capable of attaching a bag in an open state, and a casing having an upper surface serving as an input port of accommodating objects, the casing accommodating the frame to enable the frame to be pulled out together with the bag in an open state. Means peculiar to this structure is configured such that while rotation of the pair of winding shafts is restricted when the frame is pulled out from the casing, the pair of winding shafts is rotatable when the frame is accommodated in the casing. More specifically, connecting gears are provided between the pair of winding shafts and a driving source thereof such that while the connecting gears mesh with each other to transmit a rotational force from the driving source to the pair of winding shafts when the frame is accommodated in the casing, connection of the connecting gears is released when the frame is pulled out.

The frame may be configured to be able to maintain a bag in an open state allowing accommodating objects to be thrown within a period from attaching of the bag until the pair of winding shafts is rotationally driven. More specifically, besides a frame formed in an endless loop shape in plan view, there can be used a frame in a substantially U-shape turned sideways as a whole, including a pair of left and right side bars parallel to each other, each of which is provided at its central portion with a winding shaft, and a connecting bar connecting one ends of the respective side bars, the other ends of the respective side bars being opened, as long as the bag can be maintained in an open state against weight of accommodating objects while the accommodating objects are thrown.

In particular, the frame having a substantially U-shape turned sideways in plan view is a preferable structure of being accommodated in a casing in a pullout manner. That is, when a frame is in the shape of a loop, it is conceivable that its near side may obstruct removal of opposite ends of a bag mouth in a roll shape from the winding shafts, and may cause the opposite ends to be difficult to be tied down in the casing. However, when the frame in a U-shape turned sideways is accommodated in the casing to allow the other ends (the frame open end) of the respective pair of side bars to be pulled out, a front face of the frame to be a working front face is opened to not only facilitate removal of a bag mouth in a roll shape from the winding shafts while a bag is accommodated in the casing, without pulling out the frame, but also enable opposite ends of the bag mouth to be tied down. When the frame in a U-shape turned sideways is accommodated in the casing to allow its front to be an opened end as described above, a bag can be completely sealed in the casing. As a result, even when shreds being accommodating objects scatter, the outside of the casing is not contaminated to cause only the inside of the casing to be cleaned.

When the frame of a pull-out type with the front opened includes handles provided on the respective other ends of the pair of side bars, pulling out of the frame becomes easy.

As specific means for detachably attaching a bag opened to the frame, it is preferable that the frame includes a temporary fastener for temporarily holding a mouth edge of the bag in a detachable manner until the winding shaft starts to be rotationally driven. A clip elastically clamping a mouth edge of a bag corresponds to the temporary fastener. The clip has a concept that besides an existing double clip and clothespin, capable of clamping a bag mouth by themselves, a pin stopper to stop the hair is also available as the clip, and that the clip includes a leaf spring clamping a bag mouth between the leaf spring and the frame, and the like. When the frame is made of magnetic material, a magnet can be used as a temporary fastener. This means enables a bag to be maintained in an open state by providing the temporary fasteners at four respective places to cause a bag mouth to open in a rectangular shape in plan view until completion of throwing accommodating objects to a predetermined volume. At the time of winding operation after the accommodating objects stops being thrown, the bag mouth can be easily removed from the temporary fasteners. In addition, when a receiving base for a bag is provided integrally with a frame while being suspended from the frame, a bag is allowed to float from a floor to enable transfer of the bag without causing a bottom of the bag to be brought into contact with the floor. The receiving base also supports weight of accommodating objects in the bag, so that the bag mouth can be reliably maintained in an open state while the accommodating objects are thrown.

As specific means for configuring the winding shaft, it is preferable that the winding shaft is axially provided in its leading end portion with a slit for inserting the mouth edge of the bag, and that a spring for elastically holding the mouth edge inserted is provided in the slit. This is because the mouth edge of the bag in an open state can be not only easily attached to the winding shaft by hand, but also prevented from being accidentally pulled out from the winding shaft during winding.

While a bag mouth edge may become tightly wound in the leading end portion of the winding shaft in accordance with weight of accommodating objects thrown in the bag, forming an outer peripheral surface of the leading end portion in a tapered shape enables reduction in a force required for pulling out the wound mouth edge from the winding shaft.

Depending on bag material, the number of windings, and the like, a bag mouth in a roll shape wound by the winding shaft may be restored to an open state by twisting back after winding stops. To prevent this, it is preferable that the winding shaft or a rotating shaft in a power transmission path between the winding shaft and a driving source is provided with a one-way clutch that allows rotation of the winding shaft in a winding direction and restricts rotation in a reverse direction.

Accommodating objects are not particularly limited, and may be garbage such as foods and small articles as long as they can be packed into a bag. In addition, while a bag needs to have a bottom closed from the beginning, any material is available for the bag as long as it is suitable for accommodating objects.

The present invention also provides a shredder including a shredding unit for discharging shreds, as a suitable example that is particularly likely to be scattered, downward, and a bag-closing device of the above-described means provided below the shredding unit, accommodating the shreds as accommodating objects. In this case, it is a matter of course that conventional bags each widely used, such as plastic bags, can be directly used as a bag for accommodating the shreds. When the pair of winding shafts is configured to be rotationally driven by a motor, providing a packing switch separately from a shredding switch enables a shredder with an automatic packing function to be provided.

The disclosed bag-closing device winds a mouth of a bag in an open state, after accommodating objects are thrown in the bag, in a horizontal single roll shape, so that the accommodating objects can be easily packed into the bag.

In particular, the shredder provided with this bag-closing device can not only close a bag mouth in a roll shape without scattering shreds around the bag, but also easily tie down opposite ends of the bag mouth at the center thereof even at the time of final disposal.

### BRIEF DESCRIPTION OF DRAWINGS

FIG. 1 is a schematic view illustrating a bag-closing device of a first embodiment of the present invention (bag open state).

FIG. 2 is a schematic view illustrating the bag-closing device of the first embodiment of the present invention (bag close state).

FIG. 3 is an illustration of a bag after bag-closing is completed in the bag-closing device of the first embodiment of the present invention.

FIG. 4 is an illustration of a bag that is further tied down after bag-closing is completed in the bag-closing device of the first embodiment of the present invention.

FIG. 5 is a plan view illustrating details of the bag-closing device of the first embodiment of the present invention.

FIG. 6 is a front view illustrating details of the bag-closing device of the first embodiment of the present invention.

FIG. 7 is a side view illustrating details of the bag-closing device of the first embodiment of the present invention.

FIG. 8 is a detailed side view of the bag-closing device of the first embodiment of the present invention, being accommodated in a cabinet of an existing shredder.

FIG. 9 is a schematic view illustrating a shredder of a second embodiment of the present invention (when a frame is pulled out).

FIG. 10 is a schematic view illustrating the shredder of the second embodiment of the present invention (when the frame is accommodated).

FIG. 11 is a perspective view of a modified frame of the shredder of the second embodiment of the present invention.

FIG. 12 is a detailed side view of the shredder of the second embodiment of the present invention, using the modified frame (when the frame is pulled out)

FIG. 13(a) is a detailed front view illustrating the shredder of the second embodiment of the present invention, using the modified frame, when the frame is accommodated, and FIG. 13(b) is a detailed side view illustrating the shredder of the second embodiment of the present invention, using the modified frame, when the frame is accommodated (before winding).

FIG. 14(a) is a detailed front view illustrating the shredder of the second embodiment of the present invention, using the modified frame, when the frame is accommodated, and FIG. 14(b) is a detailed side view illustrating the shredder of the second embodiment of the present invention, using the modified frame, when the frame is accommodated (after winding).

FIG. 15 is a detailed side view of the shredder of the second embodiment of the present invention, using the modified frame, after a bag mouth is wound (when the frame is pulled out).

FIG. 16 is a sectional view of a main section of a transmission gear of the shredder of the second embodiment of the present invention.

FIG. 17 is a detail side view illustrating a modification of a winding shaft.

### DESCRIPTION OF EMBODIMENTS

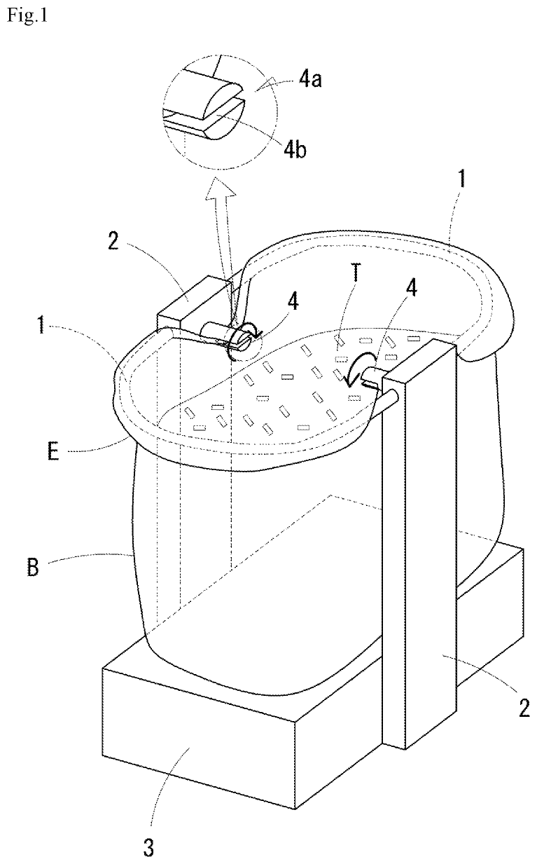

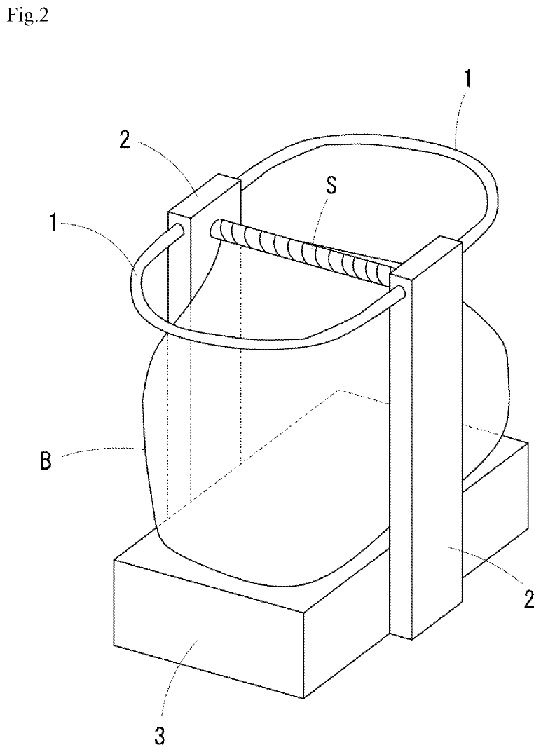

Hereinafter, preferred embodiments of the disclosed bag closing device and shredder equipped with the device will be described with reference to accompanying drawings. FIGS. 1 and 2 each illustrate a bag-closing device according to a first embodiment of the present invention. In FIGS. 1 and 2, reference numeral 1 denotes each of a front-and-back pair of frames for hanging a bag B while the bag B is opened, reference numeral 2 denotes each of a pair of left-and-right supports for supporting the frames 1, and reference numeral 3 denotes a base. The supports 2, 2 are provided in their upper end portions with a respective pair of winding shafts 4, 4 horizontally such that their respective leading end portions 4a, 4a face each other in the frames 1, 1.

In the present embodiment, the frames 1, 1 allows a bag B to be mounted thereon while a mouth edge E of the bag B is flipped outward, so that the bag B is maintained in an open state in which a predetermined volume of wastes T can be thrown. However, this mounting mode is merely an example, and it is more preferable that the mouth edge E of the bag B may be temporarily held on each of the frames 1, 1 in a detachable manner by using a temporary fastener such as a clip or the like, as described below.

The pair of winding shafts 4, 4 holds and winds two places in the mouth edge E of the bag B mounted to the frames 1 in an open state, the two places facing each other. The pair of winding shafts 4, 4 has the respective leading end portions 4a, 4a each having an end face provided with of one of axial slits 4b, 4b into which the mouth edge E is inserted, and base ends that are rotatably supported in the respective supports 2, 2.

A method for using the bag-closing device according to the first embodiment and an operation effect thereof will be described below. First, an appropriate bag B is mounted to the frames 1 while its mouth edge E is flipped outward as described above. At that time, two places facing each other in the mouth edge E are inserted into the respective leading end slits 4b, 4b of the corresponding winding shafts 4, 4. Next, when predetermined wastes T are thrown into the bag B, the winding shafts 4, 4 are rotationally driven. When the winding shafts 4, 4 are rotationally driven, each of the two places in the mouth edge E inserted into the corresponding one of the slits 4b, 4b is wound around an outer periphery of the corresponding one of the leading end portions 4a, 4a. While this winding is continued, the mouth edge E other than the two places mounted to the frames 1, 1 is gradually pulled out on the axis of the winding shafts 4, 4, and the entire mouth edge E is finally formed into a closed mouth S in a horizontal single roll shape with portions held by the respective winding shafts 4, 4, serving as opposite ends, as illustrated in FIG. 2.

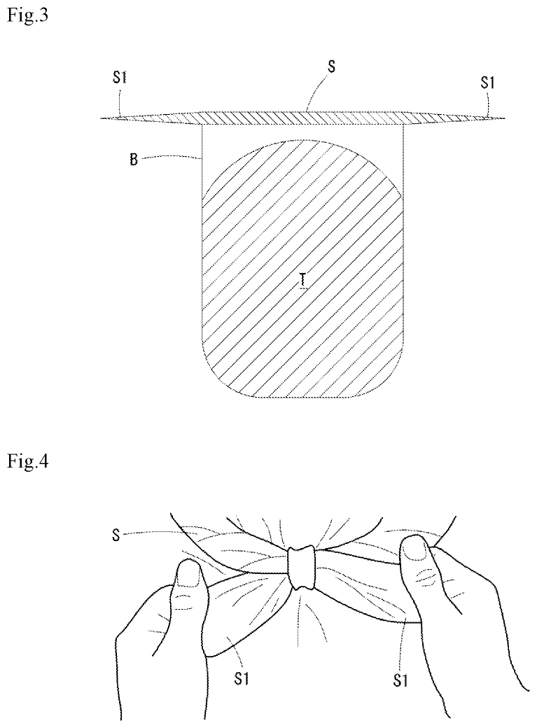

When opposite ends S1, S1 of the closed mouth S are pulled out from the winding shafts 4 and 4, the bag B can be taken out from the device while its mouth is closed by the closed mouth S as illustrated in FIG. 3. After that, how to process the closed mouth S may be appropriately determined to discard the bag B, and it is convenient to tightly tie down the opposite ends of the closed mouth S in a roll shape while the opposite ends are pulled out toward the center of the closed mouth S, as illustrated in FIG. 4, for example.

In the above embodiment, the winding shafts 4, 4 are rotated in directions opposite to each other (arrow directions in FIG. 1) when the mouth edge E is wound. As a result, the closed mouth S in a roll shape is formed in a twisted state to enhance sealing performance of the bag B. However, even when the winding shafts 4, 4 are rotated in the same direction, the closed mouth S in a roll shape can be formed, and thus the winding shafts 4, 4 may be rotated in any direction.

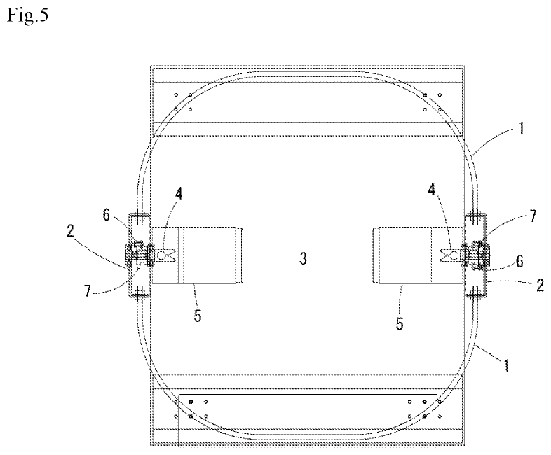

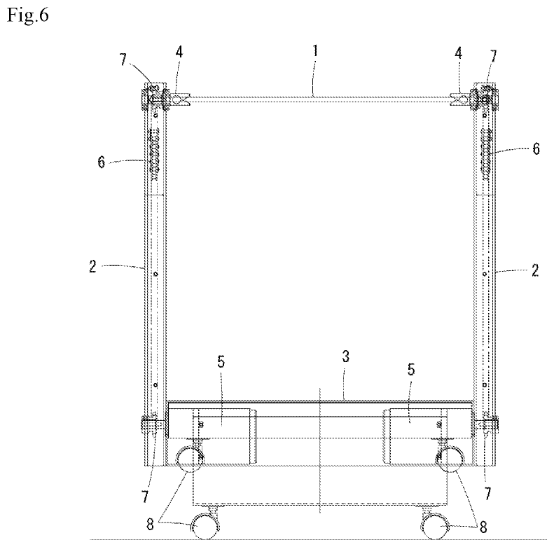

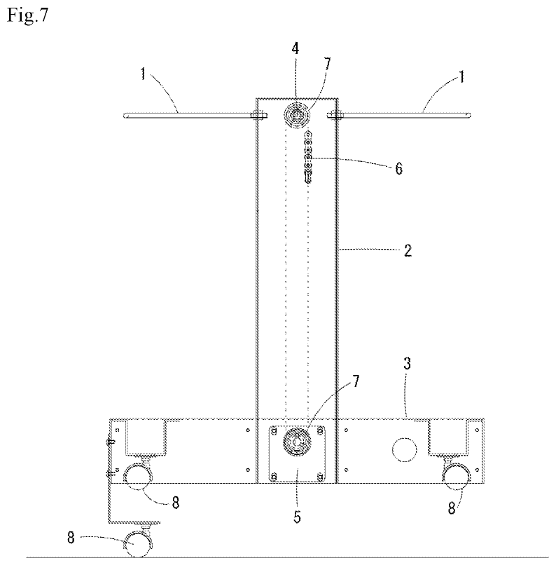

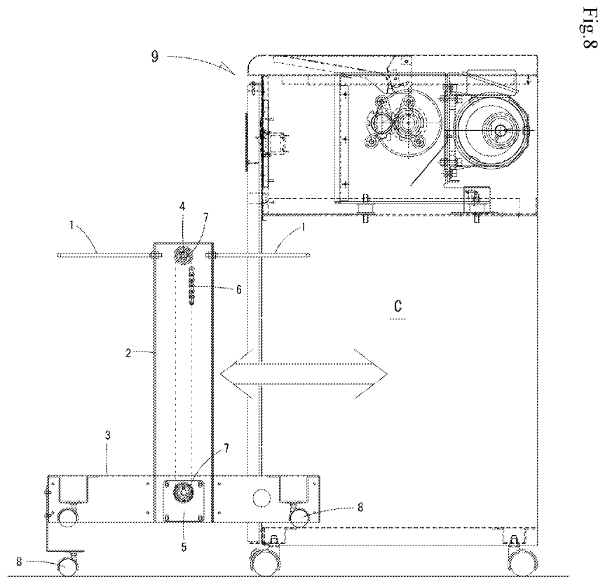

FIGS. 5 to 7 each illustrate the bag-closing device according to the first embodiment in more detail. The same reference numerals are given to parts corresponding to those in FIGS. 1 and 2. As illustrated in these detailed drawings, motors 5, 5 are used as driving sources for the winding shafts 4, 4, respectively, in the first embodiment. The motors 5, 5 are incorporated in a base 3. As means for transmitting torque, the supports 2, 2 incorporate chains 6, 6, respectively, and base ends of motor shafts and the winding shafts 4, 4 are each provided with the corresponding one of chain sprockets 7, 7 for stretching the respective chains 6, 6. This structure enables the present device to serve an automatic packing machine when means for controlling a motor (not illustrated) such as a switch or the like is additionally provided. However, rotational driving sources of the respective winding shafts 4, 4 are not limited to the motors 5, 5, and the winding shafts 4, 4 can also be rotated with respective manual handles.

In addition, the bag-closing device according to the first embodiment enables a cabinet C (corresponding to a casing in the scope of claims) in which a waste bag is set to be accommodated to be able to be pulled out from even an existing shredder 9 by attaching rollers (wheels) 8, 8 to a lower surface of the base 3, as shown in FIG. 8.

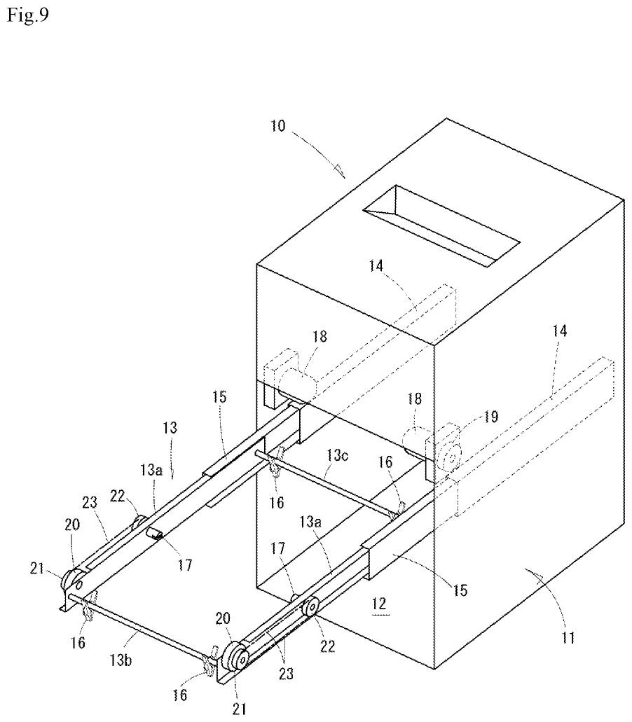

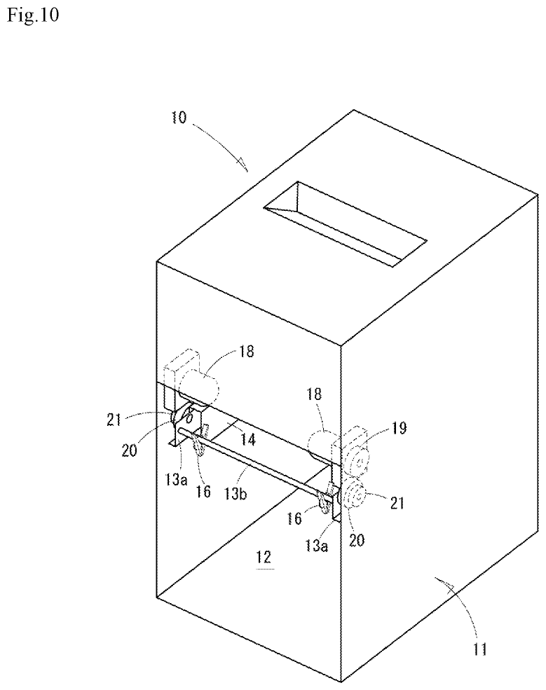

FIGS. 9, 10 each illustrate a shredder according to an embodiment (second embodiment) of the present invention, having structure in which a bag-closing device 11 is assembled on a lower side of an accommodating section 10 for a shredding mechanism (corresponding to the shredding portion in the claims), for example. In the present embodiment, a cabinet 12 (corresponding to a casing described in the claims) capable of accommodating a predetermined waste bag is formed on the lower side of the accommodating section 10 for a shredding mechanism, and the cabinet 12 is provided with a frame 13 on which a mouth edge of a waste bag is mounted while being opened, the frame 13 being able to be pulled out from the cabinet 12. That is, a pair of fixed rails 14 is provided on respective left and right side plates of the cabinet 12, and slide rails 15 are slidably inserted into the respective fixed rails 14 to form two-stage rails, and then a left-and-right pair of side bars 13a, 13a of the frame 13 is slidably inserted into the corresponding slide rails 15. Then, connecting bars 13b, 13c are provided between the side bars 13a, 13a on a front side being the front to be pulled out and a rear side opposite to the front side, respectively. The front connecting bar 13b is used as a handle to integrally slide the pair of side bars 13a, 13a. The front and rear connecting bars 13b and 13c are provided at their opposite ends with respective clips 16 to hold four places in a mouth edge of a waste bag, so that the waste bag can be mounted to the frame 13.

In the frame 13 of a pull-out type, the left and right side bars 13a, 13a are provided at their central portions with the same respective winding shafts 17, 17 each with a slit as those of the first embodiment. As a structure for rotationally driving the winding shafts 17, 17, a pair of motors 18 each serving as a driving source is provided at respective places on the respective fixed rails 14 inside the corresponding left and right side plates of the cabinet 12, and each of the motors 18 has an output shaft provided with a drive gear 19. In addition, each of the side bars 13a is provided on its front side to be pulled out with a transmission gear 20 that can mesh with the drive gear 19 on the corresponding one of winding shaft 17, 17 sides. As illustrated in FIG. 9, the transmission gear 20 does not mesh with the drive gear 19 when the frame 13 is pulled out from the cabinet 12, and as illustrated in FIG. 10, the transmission gear meshes with the drive gear 19 when the frame 13 is completely placed in the cabinet 12. In addition, chain sprockets 21, 22 are provided on the same axis of the transmission gear 20 and on the rotation axis of the winding shaft 17, respectively, and a chain 23 is stretched between both the chain sprockets 21, 22.

In the second embodiment having the above structure, an empty waste bag is mounted to the frame 13 with the clips 16 in the state of FIG. 9, and then two places in a mouth edge of the bag, facing each other, are inserted into the respective winding shafts 17. When setting of the bag is completed, the frame 13 is sled together with the bag to be accommodated in the cabinet 12 to form the state of FIG. 10. In the state of FIG. 10, documents or the like are shredded with a shredding unit in the accommodating section 10 for a shredding mechanism as usual. When a predetermined volume of shreds is accommodated in the waste bag, the motors 18 are driven by separately operating a switch (not illustrated) or by detecting that the waste bag becomes full of shredded wastes using a sensor. Then, power of the motor 18 is transmitted to the drive gear 19, the transmission gear 20, the chain sprocket 21, the chain 23, the chain sprocket 22, and the winding shaft 17, in the order described above, to enable the winding shaft 17 to be rotationally driven. After this, the mouth edge is wound around an outer periphery of the winding shaft 17 being rotationally driven, and then the entire mouth edge is finally formed into a closed mouth in a horizontal single roll shape as with the first embodiment.

Then, as with the first embodiment, after the closed mouth is formed to close the bag, opposite ends of the closed mouth are pulled out from the corresponding winding shafts 17 to take out the waste bag from the cabinet 12. The closed mouth is tied down as illustrated in FIG. 4, if desired.

When an operator tries to tie down the waste bag after the closed mouth is formed immediately below the frame, the operator needs to extend their arm from the outside of the frame to the closed mouth. Unfortunately, the first and second embodiments described above each have the frame in a loop shape, so that it is conceivable that the frame may become an obstacle to cause the tying down operation to be difficult. Particularly, when the frame 13 of a pull-out type is used as in the second embodiment, the tying down operation is limited to that performed from the front of the cabinet 12. Thus, when an operator tries to tie down a waste bag while the waste bag is accommodated in the cabinet 12 to prevent scattering of shreds more, the operator is forced to operate in a narrow space.

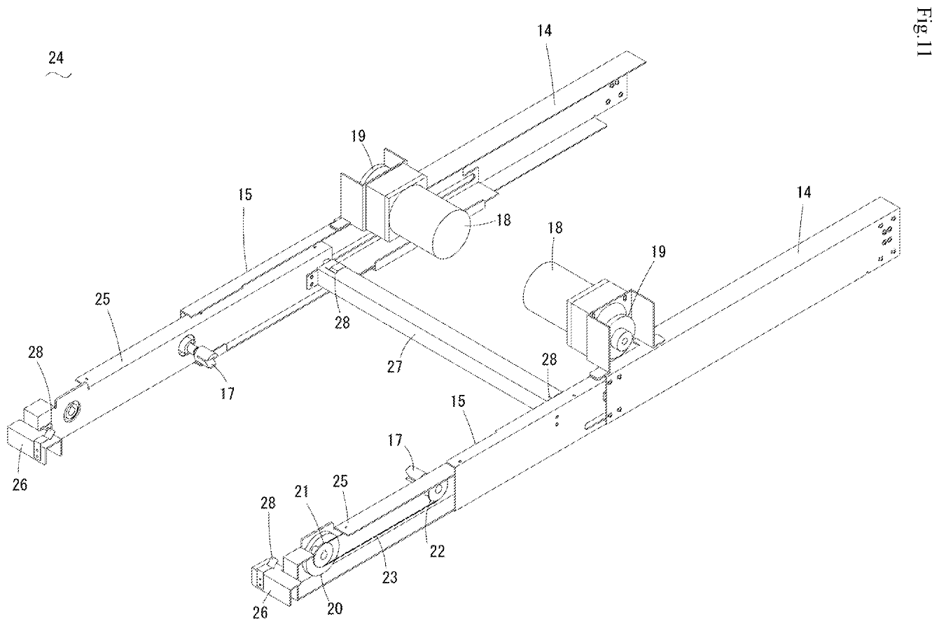

To cope with such a problem, a frame 24 in a U-shape turned sideways in plan view with a opened front side to be pulled out may be used, as illustrated in FIG. 11. That is, the modified frame 24 has a change from the second embodiment, in which it has a front side opened while projecting as it is without including a component connecting front sides of the respective side bars 25, 25 being parallel to each other, like the connecting bar 13b of the second embodiment. There is basically no difference from the second embodiment in components other than the opened front side of the frame, so that the same reference numerals as those in the second embodiment denote the same components as those in the second embodiment.

Using the frame 24 with the opened front side to be pulled out as described above allows an operator to enter more back side of the frame 24 when tying down the waste bag to facilitate operation of the tying down.

Meanwhile, the modified frame 24 includes short handles 26 each provided at a leading end of the corresponding one of the side bars 25 on the front side so as not to lose a portion to be used for transfer of the modified frame 24 into and from the cabinet 12 by eliminating the connecting bar 13b from the front side.

The modified frame 24 includes a square pipe 27 as a component for connecting the side bars 25 on their rear sides to ensure strength instead of the connecting bar 13c that is a bar in the second embodiment.

In addition, the modified frame 24 includes leaf springs 28 as means for maintaining a mouth edge of a mounted bag in an open state instead of the clips 16 of a clothespin type in the second embodiment. The leaf springs 28 are provided in respective handles 26 and respective two right and left places in the square pipe 27 to temporarily hold four places in the mouth edge of the bag.

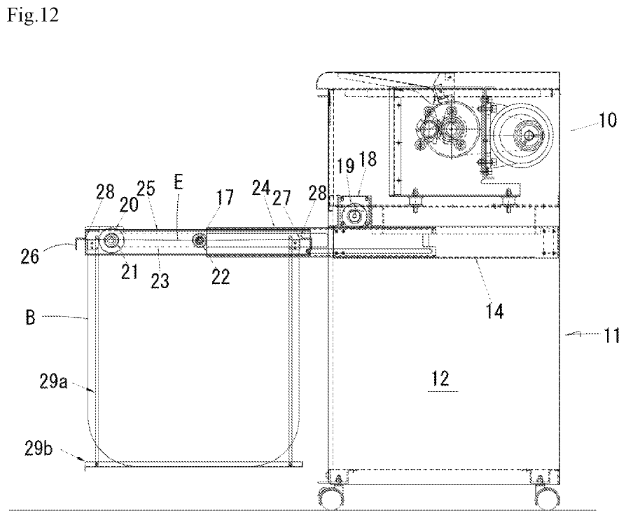

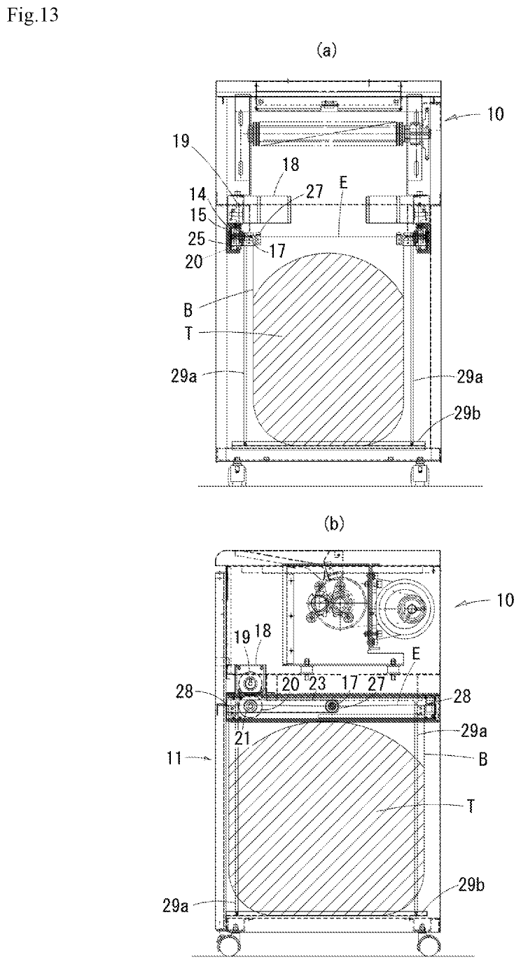

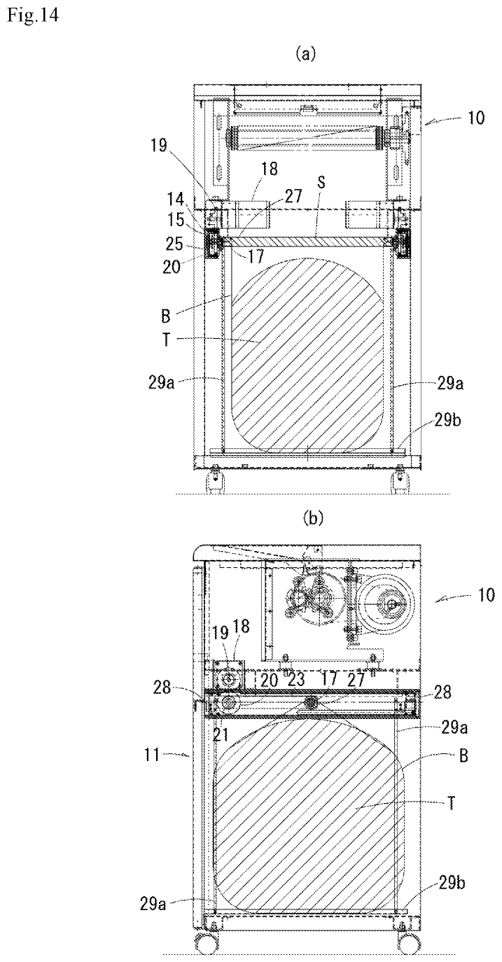

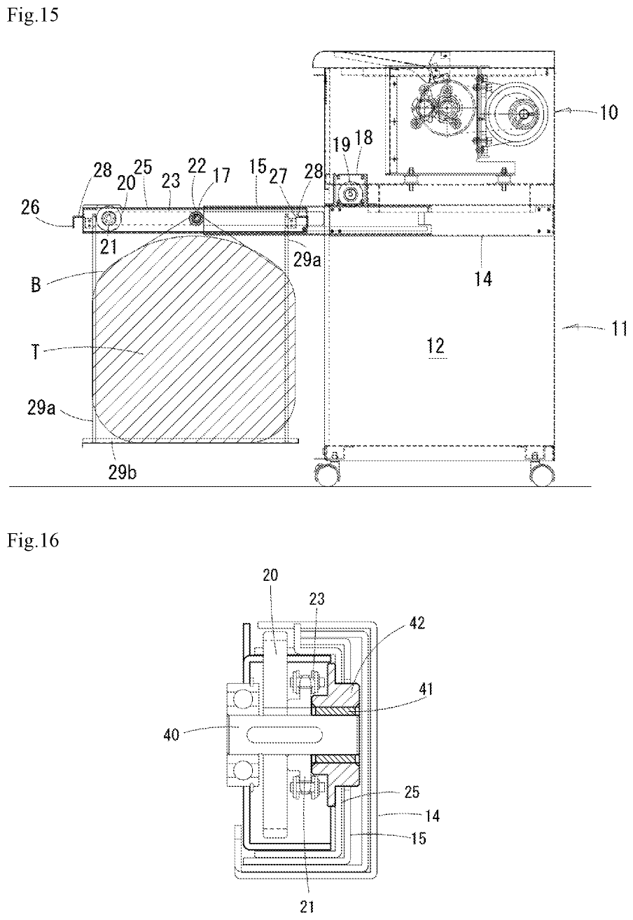

FIGS. 12 to 15 each illustrate a shredder according to a third embodiment of the present invention in which the modified frame 24 is used with the shredder of the second embodiment as a basic structure. The same reference numerals as those of the modified frame 24 and the second embodiment denote components common to those of the modified frame 24 and the second embodiment. The third embodiment further includes a bag receiving base 29b provided below the side bars 25 with vertical bars 29a suspended from the corresponding side bars 25, as a change point from the modified frame 24. As a result, the bag receiving base 29b is integrated with the frame 24 in a suspended state, and when the waste bag is set in the frame 24 with the leaf springs 28, the bag is in a floating state. This enables smooth transfer of the waste bag into and from the cabinet 12 without causing a bottom of the waste bag to be brought into contact with a floor. The bag receiving base 29b also supports weight of shreds, so that a bag mouth can be prevented from being inadvertently detached from the frame 24 (leaf springs 28) due to the weight. Other than that, the modified frame 24 including the opened front, and the added or modified components 26 to 29b, does not change the operation of the winding shaft 17, and general operation thereof is the same as that of the second embodiment.

When the winding force is eliminated by stopping driving of the winding shaft, the closed mouth S of the waste bag tends to restore its open state by twisting back due to elasticity of bag material. Particularly, when the frame is pulled out in the second and third embodiments each including the frame of a pull-out type, the transmission gear 20 becomes free to rotate, and the winding shaft 17 connected to the transmission gear 20 with the chain 23 is also free to rotate. This may allow closed mouth S of the bag to restore its open state by causing the transmission gear 20 and the winding shaft 17 each to rotate in a direction opposite to the winding direction following the twisting back of the closed mouth S of the bag. This is remarkable when bearings are used for the winding shaft 17 and the transmission gear 20.

As a more preferable structure for restricting reverse rotation of the winding shaft 17 as described above, a one-way clutch 41 that allows only rotation in the winding direction is provided on a rotating shaft 40 of the transmission gear 20 to restrict rotation of the transmission gear 20 in the direction opposite to the winding direction when the frame is pulled out, as illustrated in FIG. 16. This also restricts rotation of the winding shaft 17 in the direction opposite to the winding direction, so that restoring of the bag closed mouth S to its open state due to twisting back thereof is prevented. As a result, the closed mouth state in a roll shape on the axis of the winding shafts 17 can be maintained during a period from completion of winding to removal of the bag.

While the one-way clutch 41 is press-fitted into a dedicated housing 42 fixed to the side bar 25 to control rotation of the transmission gear 20, a target member provided with the one-way clutch 41 is not limited to the transmission gear 20. The one-way clutch 41 can be provided on any one of rotating shafts constituting a power transmission path from the driving source (motor) to the winding shaft, such as motor shaft, and further may be provided on the winding shaft 17. In this case, a reverse rotation prevention function can be imparted also to a bag-closing device without a transmission gear, including the winding shaft 4 directly connected to the motor 5 using the chain 6, as in the first embodiment.

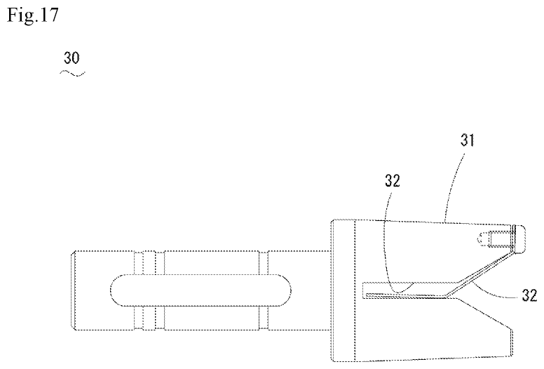

Finally, FIG. 17 illustrates a more preferable structure of the winding shaft. That is, a winding shaft 30 illustrated has an outer peripheral surface 31 to be used for winding a mouth edge of a bag in its leading end portion, being formed in a tapered shape. As a result, the winding surface of the winding shaft 30 in its leading end portion has a gradient to enable reduction in a force required to pull out a bag mouth in a roll shape from the winding shaft 30 after completion of winding.

The winding shaft 30 also includes a leaf spring 33 inside a slit 32 as means for detachably holding a bag mouth edge. As a result, using the leaf spring 33 enables the bag mouth edge to be held more reliably as in the embodiments described above, while the slit alone may cause the mouth edge to be inadvertently detached from the slit 32 before winding due to throwing of shreds, or the like.

### INDUSTRIAL APPLICABILITY

While the present invention is described in the embodiments mainly for the device for packing shreds put through a shredder into a bag, accommodating objects of a bag, and material and size of a bag are not particularly limited to those in the description, and thus the present invention may be applied to garbage such as foods and small articles that are conventionally packed into a bag.

### REFERENCE SIGNS LIST

1 flame
2 support
3 base
4 winding shaft
4a leading end portion
4b slit
5 motor
6 chain
7 chain sprocket
8 roller
9 shredder
10 accommodating section for a shredding mechanism
11 bag-closing device
12 cabinet
13 flame
13a side bar
13b connecting bar (front side)
13c connecting bar (rear side)
14 fixed rail
15 slide rail
16 clip (clothespin type)
17 winding shaft
18 motor
19 drive gear
20 transmission gear
21⋅22 chain sprocket
23 chain
24 modified frame
25 side bar
26 handle
27 square pipe
28 leaf spring
29a vertical bar
29b bag receiving base
30 winding shaft
31 outer peripheral surface of leading end portion
32 slit
33 leaf spring
40 rotating shaft of transmission gear
41 one-way clutch
42 one-way clutch housing
B bag
E mouth edge
T waste
S closed mouth
C cabinet

1. A bag-closing device comprising a pair of winding shafts having leading end portions for detachably holding, from outside of a bag, two respective opposing places in a mouth edge of the bag that is opened to allow accommodating objects to be thrown in the bag, the pair of winding shafts facing each other horizontally, wherein
the pair of winding shafts is rotationally driven so that the whole of said mouth edge of said bag into which said accommodating objects are thrown is formed in a horizontal single roll shape with the two places in the mouth edge held by said respective leading end portions, serving as opposite ends.

2. The bag-closing device according to claim 1, further comprising a casing having an upper surface serving as an input port of the accommodating objects, the casing being capable of placing the bag in an open state, wherein
the pair of winding shafts is provided inside the casing while facing each other.

3. The bag-closing device according to claim 1, further comprising a frame in which the bag is attachable in an open state, wherein
the pair of winding shafts is provided at two respective opposing places in the mouth edge of said bag attached to the frame.

4. The bag-closing device according to claim 1, further comprising:
a frame provided with the pair of winding shafts, in which the bag is attachable in an open state; and
a casing having an upper surface serving as an input port of the accommodating objects, the casing accommodating said frame to enable said frame to be pulled out together with said bag in said open state, wherein
while rotation of said pair of winding shafts is restricted when said frame is pulled out from said casing, said pair of winding shafts is rotatable when said frame is accommodated in said casing.

5. The bag-closing device according to claim 4, wherein the frame includes a pair of left and right side bars parallel to each other, each of which is provided with the winding shaft at a central portion, and a connecting bar connecting one ends of the respective side bars, the frame being in a substantially U-shape turned sideways as a whole in which the other ends of said respective side bars are opened.

6. The bag-closing device according to claim 5, wherein the frame is accommodated in the casing so as to be able to be pulled out from the casing while the other ends of the pair of side bars face a front side of the frame.

7. The bag-closing device according to claim 6, wherein the frame has a handle on each of the other ends of the pair of side bars.

8. The bag-closing device according to claim 3, wherein the frame includes a temporary fastener for temporarily holding the mouth edge of the bag in a detachable manner until the pair of winding shaft starts to be rotationally driven.

9. The bag-closing device according to claim 8, wherein the temporary fastener is a clip that elastically clamps the mouth edge of the bag.

10. The bag-closing device according to claim 3, wherein a receiving base of the bag is suspended from the frame.

11. The bag-closing device according to claim 1, wherein the winding shaft is axially provided with a slit for inserting the mouth edge of the bag in the leading end portion, and a spring for elastically holding said mouth edge inserted is provided in the slit.

12. The bag-closing device according to claim 1, wherein the winding shaft has an outer peripheral surface of the leading end portion, being formed in a tapered shape.

13. The bag-closing device according to claim 1, wherein the winding shaft or a rotating shaft in a power transmission path between the winding shaft and a driving source is provided with a one-way clutch that allows rotation of said winding shaft in a winding direction and restricts rotation in a reverse direction.

14. A shredder comprising:
a shredding unit for discharging shreds downward; and
a bag-closing device according to claim 1 provided below said shredding unit, accommodating said shreds as accommodating objects.
